(19) United States
(12) Patent Application Publication
(10) Pub. No.: US 2026/0266038 A1
(43) Pub. Date: Sep. 10, 2026

(54) TOILET ASSEMBLY

(71) Applicant: Dometic Sweden AB, Solna (SE)

(72) Inventors: Brett Breneman, Wooster, OH (US); Trevor Bender, Adrian, MI (US); Steven Miko, Wooster, OH (US)

(21) Appl. No.: 19/557,949

(22) Filed: Mar. 5, 2026

Related U.S. Application Data
(60) Provisional application No. 63/768,233, filed on Mar. 7, 2025.

(51) Int. Cl. E03D 11/13; E03D 11/02

(52) U.S. Cl. CPC E03D 11/135; E03D 11/02

(57) ABSTRACT

A toilet assembly includes a pedestal. The toilet assembly includes a bowl supported by the pedestal, the bowl including a top bowl piece and a bottom bowl piece. The top bowl piece includes a first bowl portion and an outlet at a bottom of the first bowl portion. The bottom bowl piece includes a bottom portion that defines an opening. The outlet of the top bowl piece extends through the opening of the bottom portion toward the pedestal.

### INCORPORATION BY REFERENCE

Any and all applications for which a foreign or domestic priority claim is identified in the Application Data Sheet as filed with the present application are hereby incorporated by reference herein and made a part of the present disclosure.

### TECHNICAL FIELD

The present specification generally relates to a toilet assembly and, more specifically, to a toilet assembly for use in a vehicle.

### BACKGROUND

Toilet assemblies may be used in vehicles, such as recreational vehicles, boats, and the like. In such applications, space available for the toilet assembly may be limited. Accordingly, a need exists for improved toilet assemblies for use in a vehicle and that provides a smaller footprint, increased ease of installation and/or assembly, and/or improved performance.

### SUMMARY

In one embodiment, a toilet assembly includes a pedestal. The toilet assembly includes a bowl supported by the pedestal, the bowl including a top bowl piece and a bottom bowl piece. The top bowl piece includes a first bowl portion and an outlet at a bottom of the first bowl portion. The bottom bowl piece includes a bottom portion that defines an opening. The outlet of the top bowl piece extends through the opening of the bottom portion toward the pedestal.

In another embodiment, a toilet assembly includes a bowl. The toilet assembly includes a nozzle positioned to deliver liquid to the bowl. The toilet assembly includes a vacuum breaker configured to prevent liquid from being siphoned backward from the nozzle. The toilet assembly includes a connector coupled with the bowl and fluidly coupling the nozzle and the vacuum breaker without a compression collar.

In yet another embodiment, a toilet assembly includes a bowl. The toilet assembly includes a seat supported by the bowl and moveable from a down position to an up position. The toilet assembly includes a hinge bracket supported by the bowl and pivotally coupling the seat to the bowl, the hinge bracket having an open bottom that faces the bowl and a rib extending toward the open bottom. The toilet assembly includes a damper bracket fixed to the rib. The toilet assembly includes a slow-close damper connected to the damper bracket, the slow-close damper configured to control movement of the seat.

In yet another embodiment, a toilet assembly includes a bowl. The toilet assembly includes a seat supported by the bowl and moveable from a down position to an up position. The toilet assembly includes a hinge bracket supported by the bowl and pivotally coupling the seat to the bowl. The toilet assembly includes a seat hold mechanism that includes a cam fixed to the seat and a reaction body fixed to the hinge bracket. The cam includes a radial outer surface having a movement portion configured to permit movement of the seat from the down position to the up position and a stop portion configured to maintain the seat at the up position. The radial outer surface is smooth and continuous along the movement portion and the stop portion.

In yet another embodiment, toilet assembly includes a pedestal. The toilet assembly includes a bowl supported by the pedestal. The bowl defines a rinse passage that extends around a perimeter of the bowl. The rinse passage is defined between a top wall, a bottom wall, an outer wall and an inner wall of a top portion of the bowl. The bottom wall at a front of the bowl is lower than the bottom wall at a rear of the bowl such that gravity urges fluid in the rinse passage away from the rear and toward the front.

In yet another embodiment, a toilet assembly includes a pedestal. The toilet assembly includes a bowl supported by the pedestal. The toilet assembly includes an expansion fastener securing the bowl to the pedestal. The expansion fastener includes a cylinder body. The expansion fastener includes a flange that extends radially outward from the cylinder body. The expansion fastener includes a first leg that extends axially from the cylinder body. The expansion fastener includes a second leg that extends axially from the cylinder body, the first leg and the second leg spaced from each other and defining passages therebetween. The expansion fastener includes a wedge spaced from the first leg and the second leg. The expansion fastener includes one or more first supports extending circumferentially from the first leg and the second leg to the wedge. The expansion fastener includes one or more second supports extending axially from the first leg and the second leg to the wedge.

In yet another embodiment, an expansion fastener for securing a bowl of a toilet assembly to a pedestal of a toilet assembly includes a cylinder body. The expansion fastener includes a flange that extends radially outward from the cylinder body. The expansion fastener includes a first leg that extends axially from the cylinder body. The expansion fastener includes a second leg that extends axially from the cylinder body, the first leg and the second leg spaced from each other and defining passages therebetween. The expansion fastener includes a wedge spaced from the first leg and the second leg. The expansion fastener includes one or more first supports extending circumferentially from the first leg and the second leg to the wedge. The expansion fastener includes one or more second supports extending axially from the first leg and the second leg to the wedge.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a perspective view of a toilet assembly, according to one or more embodiments shown and described herein;

FIG. 2 depicts a perspective view of a portion of the toilet assembly, according to one or more embodiments shown and described herein;

FIG. 3 depicts a cross-sectional view of a portion of the toilet assembly, according to one or more embodiments shown and described herein;

FIG. 4 depicts a cross-sectional view of a portion of the toilet assembly, according to one or more embodiments shown and described herein;

FIG. 5 depicts a cross-sectional view of a portion of the toilet assembly, according to one or more embodiments shown and described herein;

FIG. 6 depicts a cross-sectional view of a portion of the toilet assembly, according to one or more embodiments shown and described herein;

FIG. 7 depicts a perspective view of a hinge bracket of the toilet assembly, according to one or more embodiments shown and described herein;

FIG. 8 depicts a perspective view of a portion of the hinge bracket of the toilet assembly, according to one or more embodiments shown and described herein;

FIG. 9 depicts a perspective view of a seat hold mechanism of the toilet assembly, according to one or more embodiments shown and described herein;

FIG. 10 depicts a perspective view of another seat hold mechanism of the toilet assembly, according to one or more embodiments shown and described herein;

FIG. 11 depicts a cross-sectional view of a portion of the toilet assembly, according to one or more embodiments shown and described herein;

FIG. 12 depicts a cross-sectional view of another toilet assembly, according to one or more embodiments shown and described herein;

FIG. 13 depicts a cross-sectional view of a portion of the toilet assembly of FIG. 12, according to one or more embodiments shown and described herein;

FIG. 14 depicts a perspective view of an expansion fastener of the toilet assembly, according to one or more embodiments shown and described herein;

FIG. 15 depicts a side view of the expansion fastener of the toilet assembly, according to one or more embodiments shown and described herein;

FIG. 16 depicts a perspective view of a nozzle of the toilet assembly, according to one or more embodiments shown and described herein;

FIG. 17 depicts a side view of the nozzle of the toilet assembly, according to one or more embodiments shown and described herein;

FIG. 18 depicts a rear view of the nozzle of the toilet assembly, according to one or more embodiments shown and described herein;

FIG. 19 depicts a cross-section view of the nozzle of the toilet assembly taken along a line 19-19 in FIG. 18, according to one or more embodiments shown and described herein;

FIG. 20 depicts a cross-section view of the nozzle of the toilet assembly taken along a line 20-20 in FIG. 18, according to one or more embodiments shown and described herein; and

FIG. 21 depicts a cross-section view of the nozzle of the toilet assembly taken along a line 21-21 in FIG. 17, according to one or more embodiments shown and described herein.

### DETAILED DESCRIPTION

Embodiments described herein are directed to a toilet assembly that includes a pedestal, a bowl, a hinge racket, and a seat. Various embodiments of the toilet assembly and the operation of the toilet assembly are described in more detail herein. Whenever possible, the same reference numerals will be used throughout the drawings to refer to the same or like parts.

Directional terms as used herein - for example up, down, right, left, front, back, top, bottom - are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

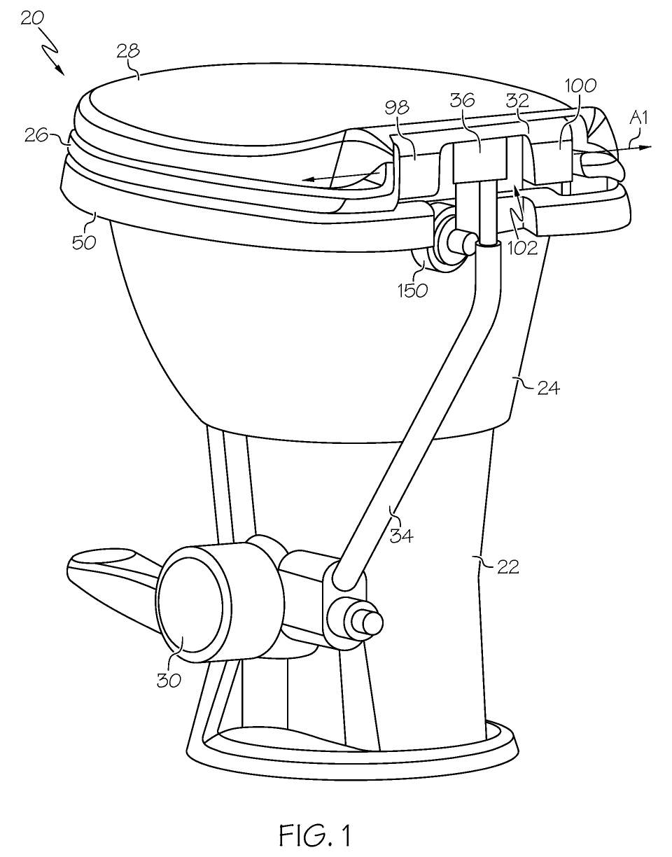

Referring now to FIG. 1, a toilet assembly 20, e.g., for use in a vehicle, such as a recreational vehicle, a boat, an aircraft, a trailer, or the like is illustrated according to one or more embodiments described herein. The toilet assembly 20 may generally include a pedestal 22, a bowl 24, a seat 26 moveable between an up position and a down position, a lid 28 movable between an open position and a closed position, and a flush lever 30. The various features of the toilet assembly 20 described herein provide a smaller footprint in a front-rear direction, e.g., relative to conventional designs; provide easier assembly and/or installation relative to conventional designs, e.g., relative to conventional designs; and/or provide better delivery of rinse liquid, e.g., relative to conventional designs.

The pedestal 22 supports, e.g., bears weight of, other components of the toilet assembly 20. The pedestal 22 may be fixed to a floor of a vehicle. The pedestal 22 may be provided at various heights, e.g., such that the toilet assembly 20 is of a “standard,” “chair,” or “comfort” height as such terms are known in relation to toilet heights. The bowl 24 is provided to receive waste from a user of the toilet assembly 20. The bowl 24 may be provided at various sizes and shapes, e.g., round or elongated as such terms are known in relation to toilet bowl sizes and shapes. The seat 26 is supported above the bowl 24. The seat 26 is supported by the bowl 24 and is included to support the user of the toilet assembly 20. The seat 26 defines an opening through which waste may be deposited into the bowl 24. The opening may be fully or partially encircled by the seat 26, e.g., the seat 26 may have an open or closed front. The seat 26 may be provided at various sizes and shapes, e.g., round or elongated and to match a size and/or shape of the bowl 24. The lid 28 is supported by the bowl 24 and is provided to selectively cover the opening of the seat 26, e.g., the lid 28 at the closed position covers the opening and the lid 28 at the open position does not cover the opening. A hinge bracket 32 is provided to pivotally couple the seat 26 and the lid 28 to the bowl 24. The seat 26 and the lid 28 pivot about a pivot axis A1, e.g., between their respective up/open positions and down/closed positions. The flush lever 30 may be fixed to the pedestal 22, e.g., below the bowl 24, and is provided as an interface for the user to flush the toilet assembly 20, e.g., to provide water or other liquid to the bowl 24 via a hose 34 and a vacuum breaker 36 and to clear and/or rinse waste from the bowl 24. The hose 34 fluidly couples the flush lever 30 to the vacuum breaker 36 such that liquid is directed from the flush lever 30 to the vacuum breaker 36.

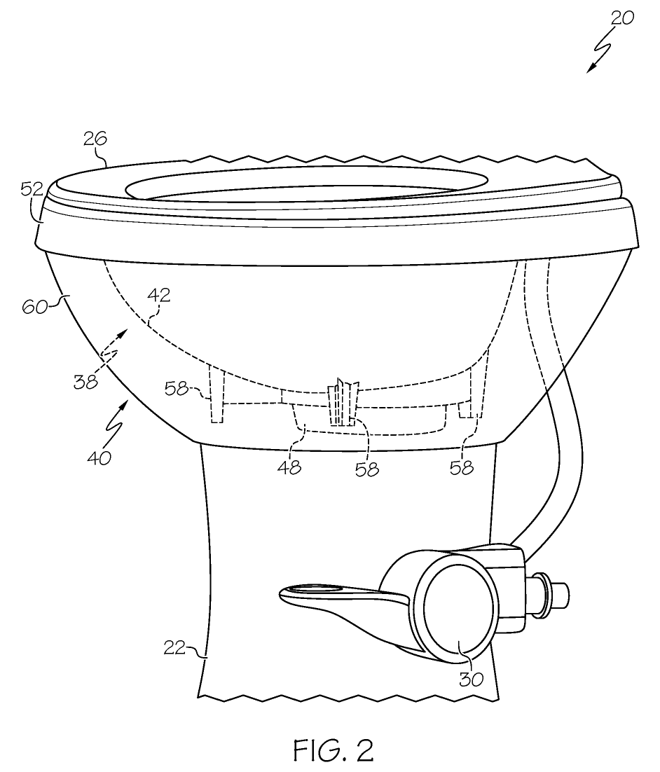

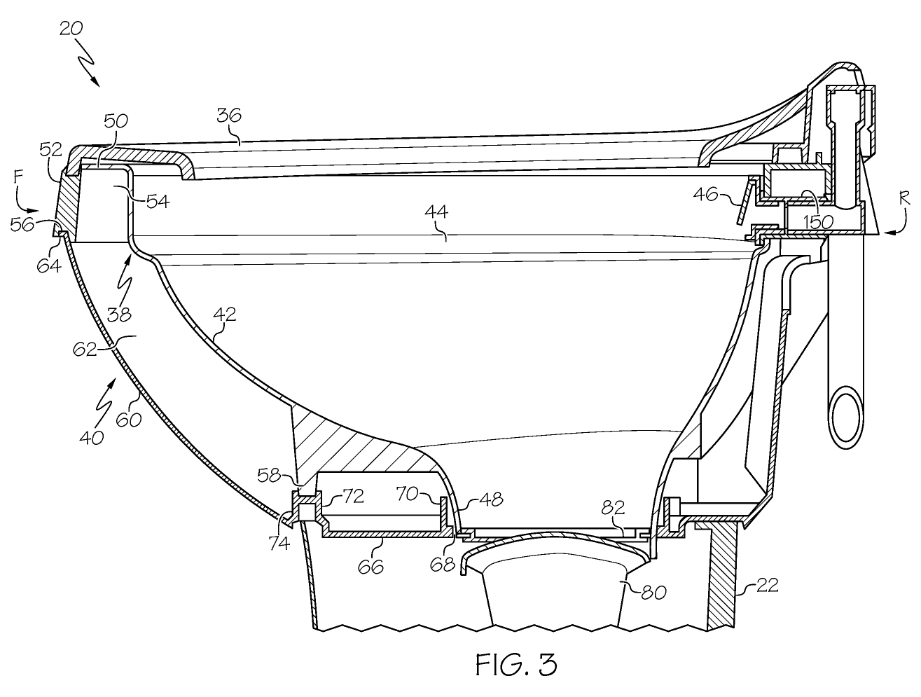

With reference to FIGS. 2 and 3, the bowl 24, in certain examples, includes a top bowl piece 38 and a bottom bowl piece 40 (the top bowl piece 38 and the bottom bowl piece 40 may alternately be referred to as inner bowl 38 and outer bowl 40). The top bowl piece 38 may generally provide an interior of the bowl 24 to receive and dispose of waste, and the bottom bowl piece 40 may generally provide an exterior shape to the bowl 24. The top bowl piece 38 may be supported by and fixed to the bottom bowl piece 40, e.g., as further discussed below.

The top bowl piece 38 includes a first bowl portion 42. The top bowl piece 38 provides an inner surface of the bowl 24 that comes in receives, e.g., with waste from the user and water upon actuation of the flush lever 30. The first bowl portion 42 generally decreases in size from top to bottom. For example, a circumference of the first bowl portion 42 proximate a top of the bowl 24 is larger than a circumference of the first bowl portion 42 proximate a bottom of the bowl 24. The first bowl portion 42 may include, a lip 44 (see, e.g., FIG. 3), channel, passage with opening, or the like configured to direct water or other rinse fluid from a nozzle 46 at a rear R of the bowl 24 to a front F of the bowl 24.

The top bowl piece 38 includes an outlet 48 at a bottom of the first bowl portion 42. The outlet 48 defines a passage through which waste, water, and/or other matter may be removed from the first bowl portion 42, e.g., when the flush lever 30 is actuated. The outlet 48 extends downward from the first bowl portion 42.

The top bowl piece 38 includes a top portion 50 that can support the seat 26. For example, the seat 26 in the down position may abut the top portion 50, and the top portion 50 may provide a normal force to the seat 26, e.g., to support a user seated on the seat 26. The top portion 50 may extend radially outward and perpendicularly or obliquely from the first bowl portion 42. The top portion 50 may be generally planar.

The top bowl piece 38 includes an outer portion 52. The outer portion 52 extends generally downward, e.g., from a radially outer edge of the top portion 50. The outer portion 52 is spaced from the first bowl portion 42 and defines a first volume 54 therebetween. The outer portion 52 defines a bottom channel 56 (see, e.g., FIG. 3). The bottom channel 56 extends along a bottom distal edge of the outer portion 52. The bottom channel 56 is open in a downward direction.

With reference to FIGS. 3, 5 and 6, the top bowl piece 38 includes one or more supports 58 that mechanically connect, e.g., transfer force from, the top bowl piece 38 to the bottom bowl piece 40 and the pedestal 22. The supports 58 extend downward from the first bowl portion 42 toward the pedestal 22. The supports 58 may abut the lower first bowl portion 42, as described below. The top bowl piece 38 can include any number of supports 58.

The top bowl piece 38, e.g., the first bowl portion 42, the outlet 48, the top portion 50, the outer portion 52, and/or the supports 58 may be monolithic. For the purposes of this disclosure, “monolithic” means a single-piece unit, i.e., a continuous piece of material without any fasteners, joints, welding, adhesives, etc., fixing multiple pieces to each other. The top bowl piece 38 may be plastic or the like. The top bowl piece 38 may be any suitable material other than plastic, e.g., resin and fiber, ceramic, porcelain, metal, or the like.

Returning to FIGS. 2 and 3, the bottom bowl piece 40 includes a second bowl portion 60 positioned below the first bowl portion 42. The second bowl portion 60 may provide an aesthetic to the bowl 24. For example, the second bowl portion 60 may have a class-A outer surface, i.e., a surface specifically manufactured to have a high-quality, finished aesthetic appearance free of blemishes. The second bowl portion 60 is spaced from the first bowl portion 42 of the top bowl piece 38 and defines a second volume 62 therebetween. The second volume 62 may be open to the first volume 54. A top edge 64 of the second bowl portion 60 may be disposed in the bottom channel 56 of the outer portion 52 of the top bowl piece 38. The top edge 64 may be secured within the bottom channel 56, e.g., via adhesive, snap-fit, friction fit, etc. The bottom channel 56 of the outer portion 52 and the top edge 64 of the second bowl portion 60 may provide a labyrinth seal, e.g., to inhibit material from entering the second volume 62 therethrough.

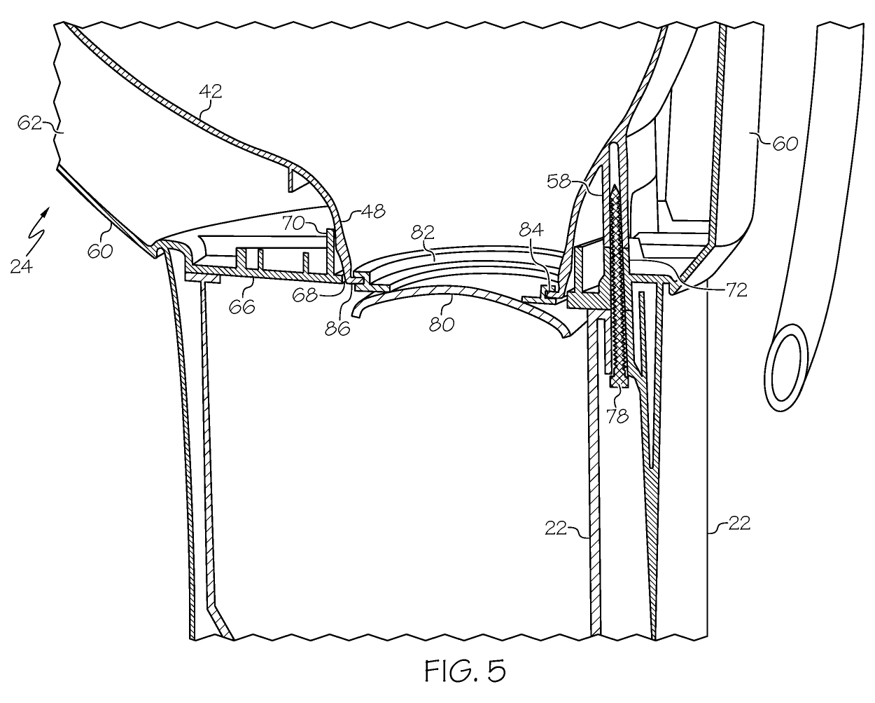

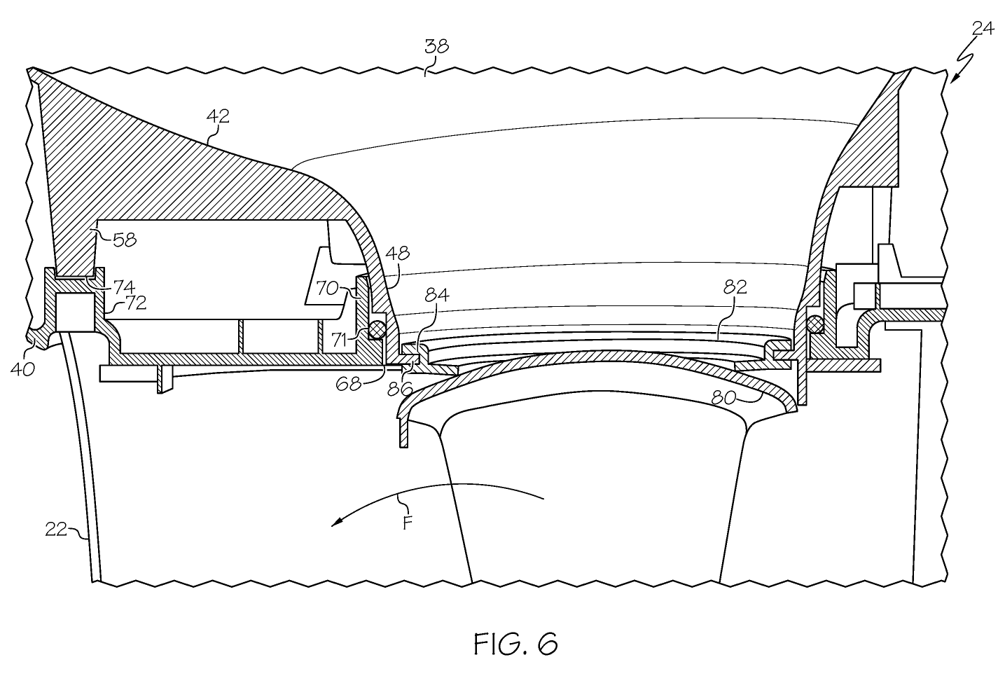

With reference to FIGS. 5 and 6, the bottom bowl piece 40 includes a bottom portion 66. The bottom portion 66 that supports other components of the bowl 24. The bottom portion 66 is disposed on top of and may abut the pedestal 22. The bottom portion 66 may extend radially inward and perpendicularly or obliquely from the second bowl portion 60. The bottom portion 66 may be generally planar. The bottom portion 66 may define an opening 68. The outlet 48 of the top bowl piece 38 extends through the opening 68 of the bottom portion 66 toward the pedestal 22, e.g., from above the opening 68 to at or below the opening 68. The outlet 48 of the top bowl piece 38 extending to at or below the opening 68 may inhibit material from flowing from the outlet 48 to the second volume 62, e.g., between an outer surface of the outlet 48 and the opening 68 of the bottom portion 66. The bottom portion 66 may include an upward extending wall 70 surrounding the opening and the outlet 48 of the top bowl 24 and extending away from the pedestal 22. The upward extending wall 70 may inhibit material from flowing from the outlet 48 to the second volume 62. A seal 71, e.g., an O-ring seal, may be disposed between the outlet 48 and the upward extending wall 71 (see FIG. 6). The seal 71 may inhibit material from flowing from the outlet 48 to the second volume 62.

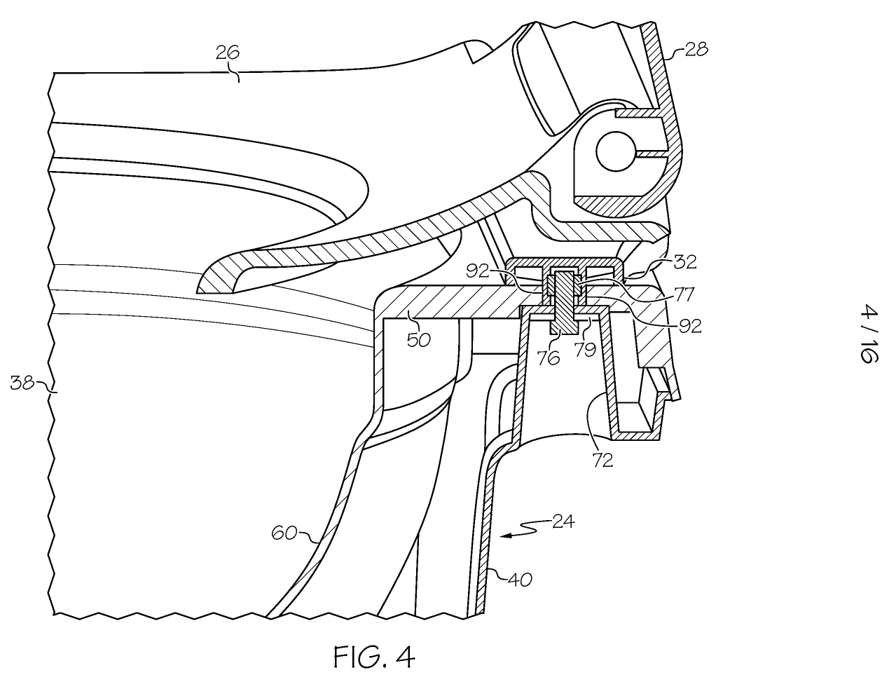

With reference to FIGS. 3-6, the bottom bowl piece 40 includes one or more bases 72 that extend away from the pedestal 22, e.g., upward from the bottom portion 66. The bases 72 may mechanically connect the top bowl piece 38 and the bottom bowl piece 40. The bases 72 may be bosses that extend upward from bottom bowl piece 40, and/or may be any other suitable structure for mechanically connecting the top bowl piece 38 and the bottom bowl piece 40. The bases 72 may abut the top bowl piece 38. In certain examples, one or more bases 72 may abut the supports 58. In certain examples, one or more bases 72 may abut the top portion 50 (see, e.g., FIG. 4). The bases 72 may define pockets 74 or the like, e.g., at distal end of the bases 72 (see, e.g., FIG. 3). The distal ends of the supports 58 may be disposed in the pockets 74 of the bases 72.

The bottom bowl piece 40, e.g., the second bowl portion 60, the bottom portion 66, and/or the bases 72 may be monolithic. The bottom bowl piece 40 may be plastic or the like. The bottom bowl piece 40 may be any suitable material other than plastic, e.g., resin and fiber, ceramic, metal, or the like. The bottom bowl piece 40 and the top bowl piece 38 may be a same type of material as each other. The bottom bowl piece 40 and the top bowl piece 38 may be different types of material than each other.

The top bowl piece 38 may be fixed to the bottom bowl piece 40, e.g., via one or more fasteners 76, 78. The fasteners 76, 78 securing the top bowl piece 38 to the bottom bowl piece 40 may additional secure other components of the toilet assembly 20. In certain examples, as shown in FIG. 4, the fasteners may include a bolt 76 that extends upward through one of the bases 72 of the bottom portion 66 and through the top portion 50 of the top bowl piece 38 to the hinge bracket 32. The bolt 76 may be engaged with, e.g., a brass nut 77 embedded in a boss 92 in the hinge bracket 32. A washer 79 or the like may be disposed in such base 72, e.g., to distribute compression force applied by the bolt 76. Additional or alternate structure may collectively fix the bottom bowl piece 40, the top bowl piece 38, and the hinge bracket 32 together, e.g., screws, rivets, or the like. In certain examples, as shown in FIG. 5, the fasteners may include a screw 78 that extends through the pedestal 22, through one of the bases 72 of the bottom bowl piece 40, and into one of the supports 58 of the top bowl piece 38. Additional or alternate structure may collectively fix the pedestal 22, the bottom bowl piece 40, and the top bowl piece 38 together, e.g., bolts, nuts, rivets, or the like.

With reference to FIG. 6, the toilet assembly 20 may include a flush ball 80, e.g., to enable flushing of the toilet assembly 20. The flush ball 80 is movable from a closed position, as shown, to an open position (not shown), e.g., as indicated by arrow F in FIG. 6. The flush ball 80 in the closed position covers the outlet 48 of the top bowl piece 38, e.g., inhibiting waste and fumes from traveling from inside the pedestal 22 and/or black water tank out through the outlet 48. In certain examples, a seal 82 may be attached or otherwise engaged with to the outlet 48. The seal 82 may extend circumferentially around the outlet 48. The seal 82 may define a channel 84 extending along a radially outward facing surface of the seal 82. The outlet 48 may include a lip 86 extending radially inward at a bottom distal end of the outlet 48. The lip 86 may be disposed in the channel 84. The flush ball 80 at the closed position may abut the seal 82, e.g., along an entire circumference of the seal 82 to form an air-tight barrier. The flush ball 80 at the open position is spaced from the outlet 48, e.g., to permit waste and other material to generally freely flow though the outlet 48. The flush ball 80 is operatively coupled to the flush lever 30 such that actuation of the flush lever 30 by a user to flush the toilet assembly 20 moves the flush ball 80 from the closed position to the open position. Release of the flush lever 30 may permit movement of the flush ball 80 back to the closed position, e.g., springs or the like configured to urge the flush ball 80 toward the closed position may be included.

With reference to FIG. 8, an underside view of the hinge bracket 32 is shown in more detail. In certain examples, the hinge bracket 32 includes an outer shell body 88. The shell body 88 extends along a front, rear, sides and top of the hinge bracket 32. The shell body 88 may be generally hollow and have an open bottom 90 that faces the bowl 24. The shell body 88 may include bosses 92, e.g., having nuts 77 embedded or otherwise secured therein to receive bolts 76 and as discussed above and shown in FIG. 4. The bosses 92 may extend from the shell body 88 at the top of the hinge bracket 32 downward to the open bottom 90. The hinge bracket 32 may include one or more internal ribs 94. The ribs 94 may extent, for example, from the shell body 88 at the front of the hinge bracket 32 to the shell body 88 at the rear of the hinge bracket 32. The ribs 94 may extend from the shell body 88 to the bosses 92. The ribs 94 may extend from the shell body 88 at the top of the hinge bracket 32 toward the open bottom 90.

The hinge bracket 32 may include a front portion 96. The hinge bracket 32 may include a first side portion 98 extending rearward from the front portion 96. The hinge bracket 32 may include a second side portion 100 extending rearward from the front portion 96. The first side portion 98 is spaced from the second side portion 100, e.g., along a right-left direction, and defines a gap volume 102 therebetween. The vacuum breaker 36 (FIG. 1) is disposed in the gap volume 102 (see FIG. 1), e.g., reducing a length of the toilet assembly 20 from the front F to the rear R and as compared to other designs. The gap volume 102 may be further defined by the top bowl piece 38, e.g., as shown in FIG. 1.

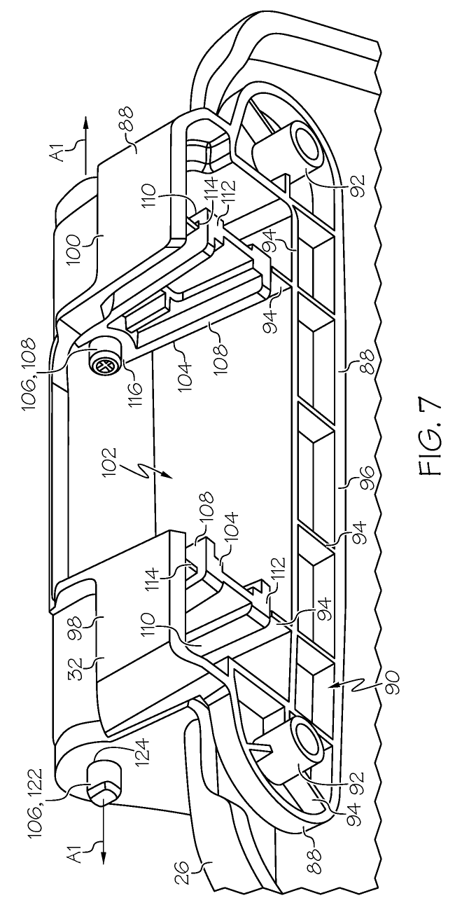

With reference to FIGS. 7 and 8, one or more damper brackets 104 may be included to connect slow-close dampers 106 to the hinge bracket 32. Each damper bracket 104 may include a first portion 108, a second portion 110, and a connecting portion 112. The first portion 108 may be spaced from the second portion 110, e.g., defining a slot 114 therebetween. The connecting portion 112 may extend from the first portion 108 to the second portion 110 and enclose one end of the slot 114. An end of the slot 114 opposite the connecting portion 112 may be open (as shown in FIG. 8). The first portion 108 may extend farther from the connecting portion 112 than the second portion 110. The first portion 108 may include a clasp 116 or other suitable structure for coupling to the slow-close damper 106. The clasp 116 may be C-shaped. The clasp 116 may be at a distal end of the first portion 108 opposite the connecting portion 112. In certain examples, a first post 118 of the slow-close damper 106 may be coupled, e.g., via snap-fit, with the clasp 116 such that rotation movement of the first post 118 relative to the clasp 116 is inhibited. The first portion 108 may inhibit lateral movement of the slow-close damper 106, e.g., by blocking movement of the slow-close damper 106 away from the gap volume 102, as shown in FIG. 7. Similarly, the second portion 110 may inhibit lateral movement of the slow-close damper 106, e.g., by blocking movement of the slow-close damper 106 toward the gap volume 102

With continued reference to FIG. 7, one or more damper brackets 104 may be fixed to the hinge bracket 32, e.g. to one or the ribs 94. For example, one damper bracket 104 may be fixed at the first side portion 98 and another damper bracket 104 may be fixed at the second side portion 100. The damper brackets 104 may be fixed to the hinge bracket 32 via snap fit and/or interference fit. For example, one of the ribs 94 at the first side portion 98 may be snap fit and/or interference fit within the slot 114 of one of the damper brackets 104, and one of the ribs 94 at the second side portion 100 may be snap fit and/or interference fit within the slot 114 of another of the damper brackets 104. The first portions 108 of both of the damper brackets 104 may face the gap volume 102. For example, the first portion 108 of each of the damper brackets 104 may be between the second portion 110 of the respective damper bracket 104 and the gap volume 102. The slow-close damper 106 coupled to the damper bracket 104 at the first side portion 98 may control movement of the seat 26. The slow-close damper 106 coupled to the damper bracket 104 at the second side portion 100 may control movement of the lid 28.

With reference again to FIG. 8, each slow-close damper 106 may include a damper body 120 that controls rotational movement of the first post 118 of the slow-close damper 106 relative to a second post 122 of the slow-close damper 106 located opposite the first post 118. The first post 118 of each slow-close damper 106 is spaced from the second post 122 of such slow-close damper 106 along the pivot axis A1, e.g., to enable pivoting the seat 26 and the lid 28 about the pivot axis A1. The damper body 120 may include hydraulic and/or mechanical structure to control rotational movement of the first post 118 relative to the second post 122, e.g., including, but not limited to, conventional structures. The second post 122 may have a flat portion, a keyway, a square cross-section, or the like to transfer torque, e.g., from the second post 122 to the seat 26 or the lid 28. For example, the second post 122 of the slow-close damper 106 at the first side portion 98 may be disposed in a first opening 124 of the seat 26, where the first opening 124 has a shape that corresponds to the shape of the second post 122 such that torque is transferred therebetween. The second post 122 of the slow-close damper 106 at the second side portion 100 may be disposed in a second opening 126 of the seat 26, where the second opening 126 has a shape, e.g., circular, and size such that torque is not transferred therebetween. Similarly, the second post 122 of the slow-close damper 106 at the second side portion 100 may be disposed in a first opening (not show) of the lid 28, where the first opening of the lid 28 has a shape that corresponds to the shape of the second post 122 such that torque is transferred therebetween. The second post 122 of the slow-close damper 106 at the first side portion 98 may be disposed in a second opening (not shown) of the lid 28, where the second opening of the lid 28 has a shape and size such that torque is not transferred therebetween. Accordingly, the slow-close damper 106 at the first side portion 98 may control movement of the seat 26 and the slow-close damper 106 at the second side portion 100 may control movement of the lid 28.

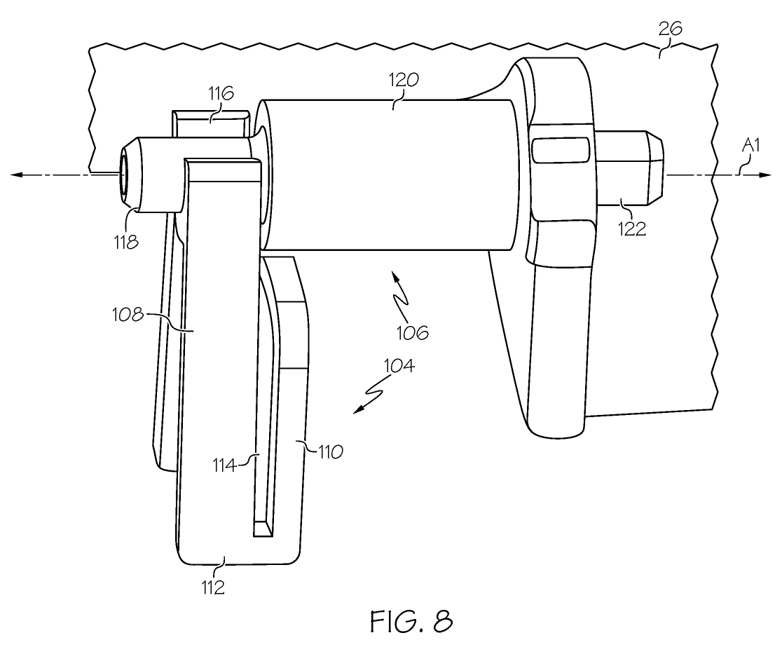

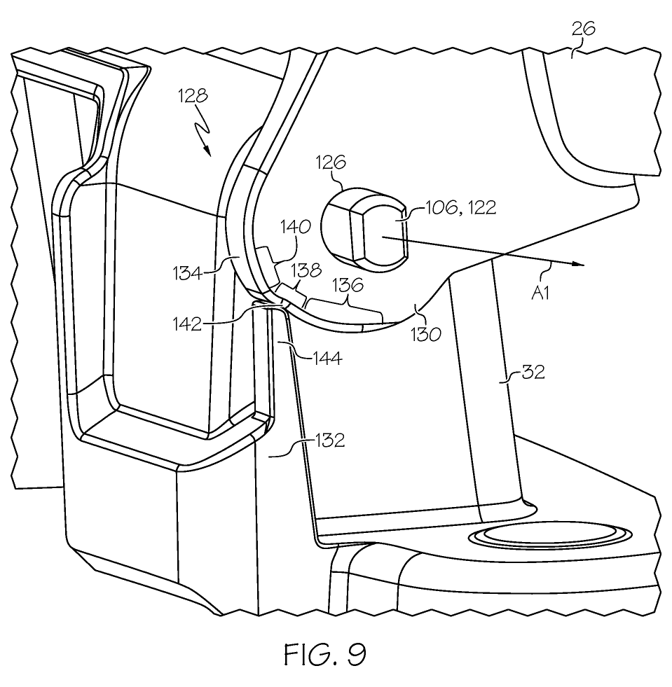

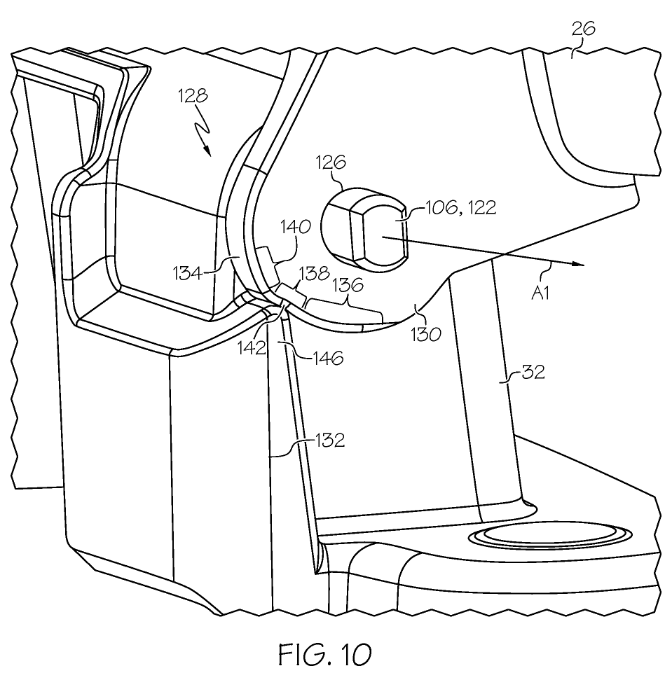

With reference to FIGS. 9 and 10, a seat hold mechanism 128 may be included to hold, e.g., maintain, the seat 26 at the up position. In certain examples, the seat hold mechanism 128 is at the second side portion 100 for the hinge bracket 32. The seat hold mechanism 128 may include a cam 130 and a reaction body 132. The cam 130 may be fixed to the seat 26, e.g. via friction welding, adhesive, one or more fasteners, etc. In some examples, the cam 130 and the seat 26 may be monolithic, for example, the cam 130 and the seat 26 may be molded as a single unit. The cam 130 rotates about the pivots axis, e.g., concurrent with the seat 26. The cam 130 may be a component of the seat 26. The reaction body 132 may be fixed to the hinge bracket 32, e.g. via friction welding, adhesive, one or more fasteners, etc. In some examples, the reaction body 132 and the hinge bracket 32 may be monolithic. Rotation of the seat 26 toward the up position may generally increase pressure applied to the reaction body 132 by the cam 130. Rotation of the seat 26 toward the down position may generally decrease pressure applied to the reaction body 132 by the cam 130. When the seat 26 is at the up position, pressure between the cam 130 and the reaction body 132 may provide sufficient reaction forces therebetween to maintain the seat 26 at the up position. The seat hold mechanism 128 may include additional and/or alternate structure, such as a latch, a snap catch, a friction disc, or the like.

The cam 130 may include a radial outer surface 134 that faces radially outward, e.g., relative to the pivot axis A1. The radial outer surface 134 may include a movement portion 136, a stop portion 138, and a blocked portion 140. The stop portion 138 is between the movement portion 136 and the blocked portion 140, e.g., circumferentially relative to the pivot axis A1. The movement portion 136 is configured to generally permit movement of the seat 26 from the down position to the up position, and vice versa. The stop portion 138 is configured to maintain the seat 26 at the up position. The blocked portion 140 is configured to prevent movement of the seat 26 past the up position. The radial outer surface 134 along the movement portion 136, along the stop portion 138, and/or the blocked portion 140 may be generally smooth and continuous. For example, the radial outer surface 134 may be generally free of having any cusps, corners, or the like.

A radial distance, e.g., from a center of the second opening 126 and/or the pivot axis A1, to the radial outer surface 134 may generally increase along the movement portion 136 toward the stop portion 138. For example, the radial distance between the radial outer surface 134 and the second opening 126 and/or the pivot axis A1 at a first location may be greater than the radial distance between the radial outer surface 134 and the second opening 126 and/or the pivot axis A1 at a second location that is farther from the stop portion 138.

The radial distance from the radial outer surface 134 to the center of the second opening 126 and/or the pivot axis A1 along the stop portion 138 is provided such that reaction forces between the radial outer surface 134 and the reaction body 132 maintain the seat 26 at the up position. The radial distance from the radial outer surface 134 at the stop portion 138 to the center of the second opening 126 and/or the pivot axis A1 may be provided such that the reaction forces generates sufficient friction between the radial outer surface 134 and the reaction body 132 to maintain the seat 26 at the up position. The radial outer surface 134 at the stop portion 138 may include an area of localized radial decrease 142 at which the radial distance from the radial outer surface 134 to the center of the second opening 126 and/or the pivot axis A1, e.g., relative to adjacent portions of the radial outer surface 134 on opposite sides of such area. The area of localized radial decrease 142 may include, for example, a detent, a depression, a valley, or the like. Normal forces between the radial outer surface 134 at the area of localized radial decrease 142 and the reaction body 132 may maintain the seat 26 at the up position.

The radial distance from the radial outer surface 134 to the center of the second opening 126 and/or the pivot axis A1 along the blocked portion 140 is provided to inhibit movement of the seat 26 away from the down position past the open position. For example, the radial distance may be of sufficient length to provide an interference between the cam 130 and the reaction body 132 that inhibits movement of the seat 26 past the up position. The radial distance at the blocked portion 140 may be greater than the radial distance along stop portion 138, and greater than the radial distance along the movement portion 136.

With reference to FIG. 9, the reaction body 132 may include a finger 144. The finger 144 may flex, e.g., as the cam 130 is rotated. The finger 144 is elongated away from the bowl 24, e.g., upward. In other words, the finger 144 may be longer in an up-down direction than in a left-right direction and a front-rear direction. A distal end of the finger 144 may be blunt and free of having any hooks, steps, or other catches that engage the cam 130. The finger 144 is supported by the reaction body 132 along a bottom of the finger 144 and not along a rear of the finger 144.

With reference to FIG. 10, the reaction body 132 may include a horn 146. The horn 146 is supported by the reaction body 132 along a rear and a bottom of the horn 14, e.g., such that the horn 146 is generally immobile and does not flex when the cam 130 is rotated.

With reference to FIG. 11, a connector 150 fluidly coupling the nozzle 46 and the vacuum breaker 36 is shown. The nozzle 46 is positioned to deliver water, or other liquid, to the bowl 24, e.g., to the first bowl portion 42 of the top bowl piece 38. The water, or other liquid, may be provided to the nozzle 46 via the vacuum breaker 36. The vacuum breaker 36 is configured to prevent water, or other liquid, from being siphoned backward from the nozzle 46, e.g., toward the hose 34 and as conventionally known. The connector 150 fluidly couples the vacuum breaker 36 to the nozzle 46 such that fluid is directed from the vacuum breaker 36 to the nozzle 46. The connector 150 may provide a tool-less coupling with the bowl 24, the nozzle 46, and the vacuum breaker 36, e.g., enabling the bowl 24, the nozzle 46, and the vacuum breaker 36 to be coupled together without requiring the use of tools or separate fasteners, such as compression collars or the like. In other words, the toilet assembly 20 may be free of having compression collars, fasteners, or other separate structure, that fix the connector 150 to the nozzle 46, and the toilet assembly 20 may be free of having compression collars, fasteners, or other separate structure, that fix the connector 150 to the vacuum breaker 36. Compression collars are structures configured to surround a hose at a coupling location and provide a seal by compressing such hose. Example compression collars include worm-drive hose clamps, tension bands, T-bolt clamps, ear clamps, screw clamps, embossed hose clamps, band clamps, and the like. The tool-less coupling provided by the connector 150, e.g., being free of having a compression collar, may provide easier assembly and maintenance of the toilet assembly 20, e.g., compared to conventional designs utilizing one or more compression collars.

The connector 150 may be generally cylindrical, e.g., having a cylinder body 162 extending from a first open distal end 152 to a second open distal end 154 opposite the first open distal end 152. The connector 150 defines and surrounds a fluid-flow passage 156 that extends from the first open distal end 152 to the second open distal end 154. A generally cylindrical portion 158 of the nozzle 46 may be disposed within the passage 156 at the first open distal end 152. A generally cylindrical portion 160 of the vacuum breaker 36 may be disposed within the passage 156 at the second open distal end 154.

The connector 150 may include a divider 164 in the passage 156 between the first open distal end 152 and the second open distal end 154. The divider 164 extends circumferentially about an inner surface of the cylinder body 162 of the connector 150 and radially inward toward the fluid-flow passage 156 and away from the inner surface of the cylinder body 162. The divider 164 may be between the generally cylindrical portion 160 of the vacuum breaker 36 and the generally cylindrical portion 158 of the nozzle 46. The divider 164 may abut the generally cylindrical portion 160 of the vacuum breaker 36 and the generally cylindrical portion 158 of the nozzle 46, e.g., limiting movement of the generally cylindrical portion 160 of the vacuum breaker 36 and/or the generally cylindrical portion 158 of the nozzle 46 in their respective directions of insertion. In other words, the divider 164 may prevent the generally cylindrical portion 160 of the vacuum breaker 36 and/or the generally cylindrical portion 158 of the nozzle 46 from being over inserted. In other words, the divider 164 may provide a stop that limits movement of the vacuum breaker 36 and/or the nozzle 46 upon insertion into the connector 150.

The connector 150 may include a first inner protrusion 166. The first inner protrusion 166 may extend circumferentially about the cylinder body 162 and radially inward from the cylinder body 162, e.g., into the passage 156. The first inner protrusion 166 may be proximate the first open distal end 152, e.g., between the first open distal end 152 and the divider 164. The first inner protrusion 166 may secure the generally cylindrical portion 158 of the nozzle 46 within the passage 156. For example, the first inner protrusion 166 may be engaged with, e.g., disposed in, a first recess 168 of the generally cylindrical portion 158 of the nozzle 46. The first recess 168 may be at an outer surface of the generally cylindrical portion 158 of the nozzle 46 and extend radially inward. Normal forces between the first inner protrusion 166 and the outer surface of the generally cylindrical portion 158 of the nozzle 46 at the first recess 168 may secure the generally cylindrical portion 158 of the nozzle 46 in the passage 156. For example, the first inner protrusion 166 may snap-fit within the first recess 168.

The connector 150 may include a second inner protrusion 170. The second inner protrusion 170 may extend circumferentially about the cylinder body 162 and radially inward from the cylinder body 162, e.g., into the passage 156. The second inner protrusion 170 may be proximate the second open distal end 154, e.g., between the second open distal end 154 and the divider 164. The second inner protrusion 170 may secure the generally cylindrical portion 160 of the vacuum breaker 36 within the passage 156. For example, the second inner protrusion 170 may be engaged with, e.g., disposed in, a second recess 172 of the generally cylindrical portion 160 of the vacuum breaker 36. The second recess 172 may be at an outer surface of the generally cylindrical portion 160 of the vacuum breaker 36 and extend radially inward. Normal forces between the second inner protrusion 170 and the outer surface of the generally cylindrical portion 160 of the vacuum breaker 36 at the second recess 172 may secure the generally cylindrical portion 160 of the vacuum breaker 36 in the passage 156. For example, the second inner protrusion 170 may snap-fit within the second recess 172.

The connector 150 may include a first lip 174 at the first open distal end 152. The first lip 174 may extend radially outward, e.g., away from the cylinder body 162. The connector 150 may have an outer protrusion 176. The outer protrusion 176 may extend circumferentially about the cylinder body 162 and radially away from the cylinder body 162. The outer protrusion 176 may be proximate the first open distal end 152, e.g., closer to the first open distal end 152 than to the second open distal end 154. The outer protrusion 176 may be spaced from the first lip 174. The connector 150 may define an outer channel 178, e.g., between the first lip 174 and the outer protrusion 176. The bowl 24, e.g., the first bowl portion 42 of the top bowl piece 38, may be disposed in the outer channel 178. The top bowl piece 38 may be snap-fit into the outer channel 178, e.g., to secure the connecter relative to the bowl 24. A first surface 180 of the outer protrusion 176 may face the outer channel 178. The first surface 180 may be generally perpendicular relative to an adjacent outer surface of the cylinder body 162. A second surface 182 of the outer protrusion 176 may extend from the first surface 180 and face away from the outer channel 178. The second surface 182 may be generally oblique relative to the adjacent outer surface of the cylinder body 162, e.g., to facilitate installation of the connector 150 to the top bowl piece 38.

The connector 150 may include a second lip 184 at the second open distal end 154. The second lip 184 may extend radially outward, e.g., away from the cylinder body 162. A first surface 186 of the second lip 184 face the outer protrusion 176. The first surface 186 may be generally perpendicular relative to an adjacent outer surface of the cylinder body 162. The first surface 186 may limit movement of the bottom bowl piece 40 away from the first open distal end 152 past the second open distal end 154. A second surface 188 of the second may extend from the first surface 186 and face away from the outer protrusion 176. The second surface 188 may be generally oblique relative to the first surface 186, e.g., to facilitate installation of the connector 150 to the bottom bowl piece 40.

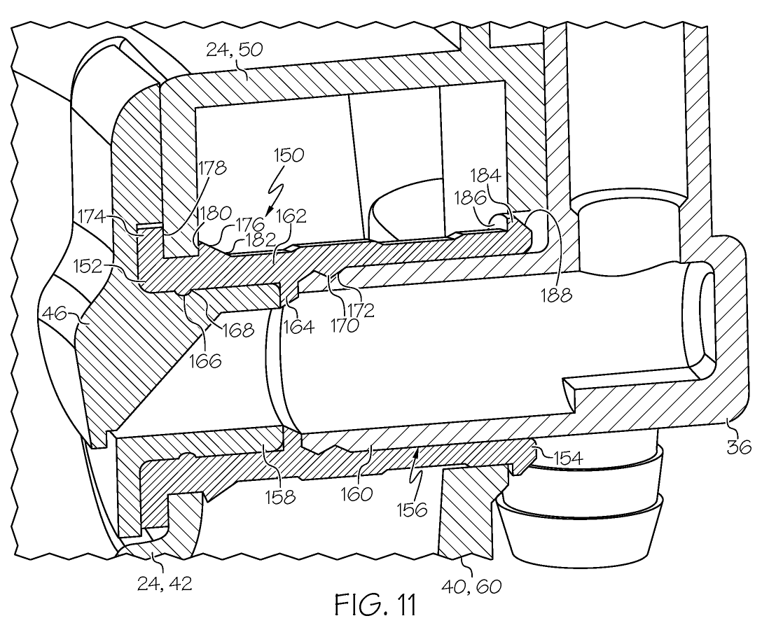

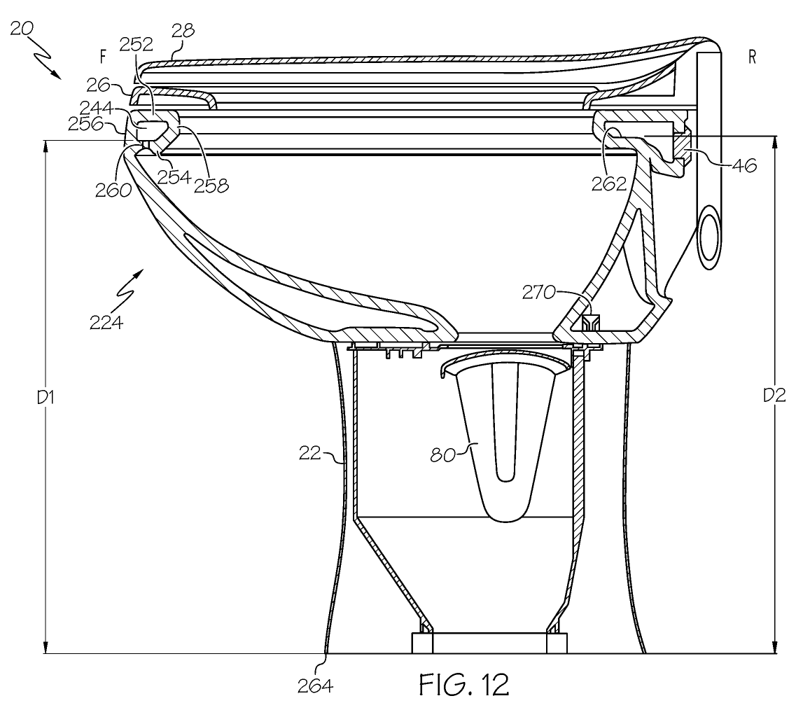

With reference to FIG. 12, a bowl 224 according to other certain examples is shown. The bowl 224 of FIG. 12 is shown as having a single-piece monolithic structure, however, it is to be understood that various features of the bowl 224 of FIG. 12, such as a rinse passage 244 defined by the bowl 224, can be incorporated into a bowl having a multiple piece design, such as the bowl 24 described above.

The rinse passage 244 of the bowl 224 provides a generally enclosed pathway for rinse fluid, e.g., water to flow. The rinse passage 244 distributes rinse fluid, e.g., received from the nozzle 46 or similar structure, about a circumference of an inner surface of a bowl portion 242 of the bowl 224. The rinse passage 244 may be defined by the bowl 224 within a top portion 250 of the bowl 224. For example, the top portion 250 may include a top wall 252 and a bottom wall 254 vertically spaced from the top wall 252. The rinse passage 244 may be between the top wall 252 and the bottom wall 254. The top portion 250 may include an outer wall 256 that extends from the top wall 252 to the bottom wall 254. The top portion 250 may include an inner wall 258 that extends from the top wall 252 to the bottom wall 254. The inner wall 258 is spaced from the outer wall 256. The rinse passage 244 may be between the inner wall 258 and the outer wall 256. The rinse passage 244 may extend around a perimeter of the bowl 224, e.g., surrounding the bowl portion 242 and extending along a rear R, sides, and front F of the bowl 224. The bowl 224 may include a plurality of rinse holes 260 arranged along the rinse passage 244, e.g., extending through the bottom wall 254 and arranged at intervals along the bottom wall 254. Rinse fluid may flow from the rinse passage 244 downward through the rinse holes 260, e.g., to rinse the inner surface of the bowl portion 242.

The rinse passage 244 may be configured to urge fluid delivered at a rear R of the bowl 224 along the rinse passage 244 toward the front F of the bowl 224. For example, the bottom wall 254 at the front F of the bowl 224 may be lower than the bottom wall 254 at the rear R of the bowl 224 such that gravity urges fluid in the rinse passage 244 generally away from the rear R and toward the front F. For example, a first distance D1 from a top surface 262 of the bottom wall 254 at the front F of the bowl 224 along a vertical axis to a bottom distal edge 264 of the pedestal 22 may be less than a second distance D2 from the top surface 262 of the bottom wall 254 at the rear R of the bowl 224 along the vertical axis to the bottom distal edge 264 of the pedestal 22.

When the toilet assembly 20 is flushed, e.g., when a user actuates the flush lever 30 (shown in FIGS. 1 and 2), rinse fluid is introduced into the rinse passage 244 at the rear R of the bowl 224. Gravity may urge such fluid along the downward slope provided by the top surface 262 of the bottom wall 254 to the front F of the bowl 224. The rinse fluid may flow out of the rinse holes 260, e.g., at sides and the front F of the bowl 224, to rinse the bowl portion 242.

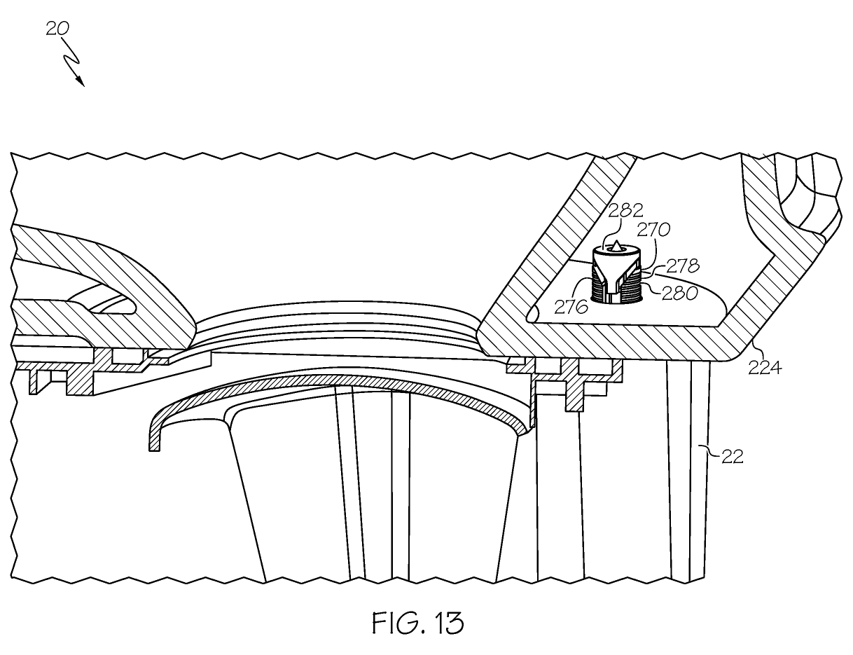

With reference to FIGS. 13-15, the bowl 224 may be secured to the pedestal 22 with an expansion fastener 270. The expansion fastener 270 may be utilized, for example, in examples where the bowl 224 is ceramic or other material that is more brittle than plastic, metal, or the like. The expansion fastener 270 may extend upward, e.g., through an opening in the pedestal 22 and an opening in the bowl 224.

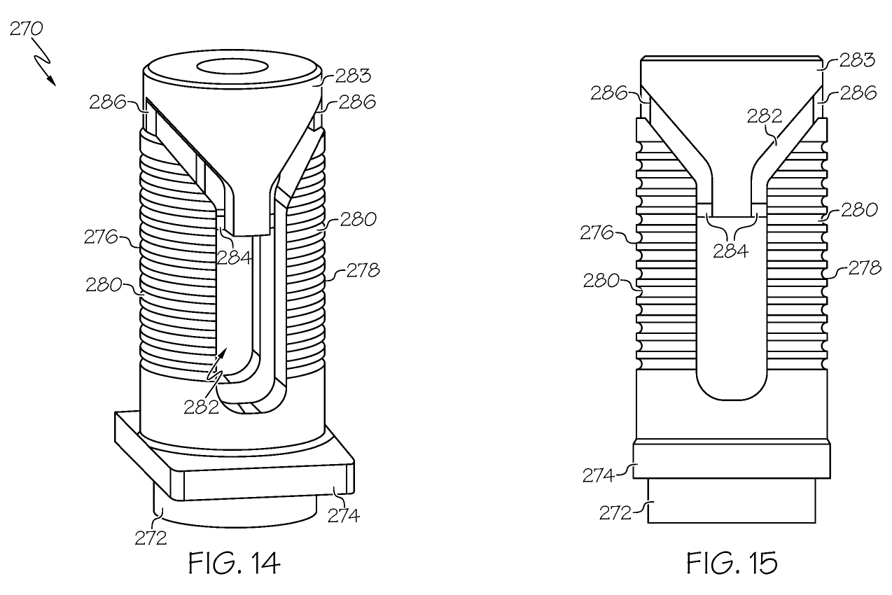

As shown in FIGS. 14 and 15, the expansion fastener 270 may include a cylinder body 272. The expansion fastener 270 may include a flange 274 that extends radially outward from the cylinder body 272. The flange 274 may be rectangular or any suitable shape. The expansion fastener 270 may include a first leg 276 and a second leg 278 that extend axially from the cylinder body 272 and away from the flange 274. The first leg 276 and the second leg 278 may each have a plurality of grooves 280 in outer surfaces of the first leg 276 and the second leg 278. The grooves 280 may be elongated circumferentially along the outer surfaces of the first leg 276 and the second leg 278. The first leg 276 and the second leg 278 may be spaced from each other, e.g., defining passages 282 therebetween. The first leg 276 and the second leg 278, e.g., surfaces of the first leg 276 and the second leg 278 that face the passages 282, may slope outward at ends of the first leg 276 and second leg 278 spaced from the cylinder body 272 such that a circumferential width of the passages 282 increases at the ends of the first leg 276 and the second leg 278.

The expansion fastener 270 may include a wedge 283. The wedge 283 may be generally cylindrical and axially aligned with the cylinder body 272. The wedge 283 may be narrowed toward the cylinder body 272. In other words, an end of the wedge 283 proximate the cylinder body 272 may be narrower than an end of the wedge 283 distal to the cylinder body 272. The wedge 283 may be spaced from the first leg 276 and the second leg 278. The wedge 283 may be, at least partially, disposed within the passages 282 between the first leg 276 and the second leg 278. A plurality of supports 284, 286 may secure the wedge 283 to the first leg 276 and the second leg 278. For example, one or more first supports 284 may extend circumferentially from the first leg 276 and the second leg 278 to an end of the wedge 283 proximate the cylinder body 272. One or more second supports 286 may extend axially from distal ends of the first leg 276 and the second leg 278 to an end of the wedge 283 distal to the cylinder body 272. The first supports 284 and the second supports 286 are of sufficient strength to generally maintain a position of the wedge 283 relative to the first leg 276 and the second leg 278, e.g., while a screw or other threaded fastener is engaged with the wedge 283. The first supports 284 and the second supports 286 may be sufficiently frangible to permit the wedge 283 to be drawn down into the passages 282, e.g., by further tightening of the screw or other fastener.

To secure the bowl 224 to the pedestal 22, the wedge 283 and legs 276, 278 of the expansion fastener 270 may be inserted upward through the opening in the pedestal 22 and the opening of the bowl 224, e.g., such that the flange 274 abuts the pedestal 22 and with a portion of the pedestal 22 between the flange 274 and the bowl 224. After insertion, a screw may be inserted upward through the cylinder body 272. The screw may extend upward between the first leg 276 and the second leg 278 and may engage the wedge 283. The screw may be tightened. Tightening the screw may draw the wedge 283 down into the passages 282 between the first leg 276 and the second leg 278. As the wedge 283 is drawn down, the supports 284, 286 may be deformed and/or separated from the legs and/or the wedge 283. Additionally, as the wedge 283 is drawn down, normal forces between the wedge 283 and the first leg 276 and the second leg 278 may urge the first leg 276 and the second leg 278 outward away from each out. Urging the first leg 276 and the second leg 278 outward and away from each other may move one or more of the grooves 280 into engagement with the bowl 224 such that the bowl 224 and the pedestal 22 are collectively secured between the flange 274 and portions of the first leg 276 and the second leg 278 that are urged apart by the wedge 283.

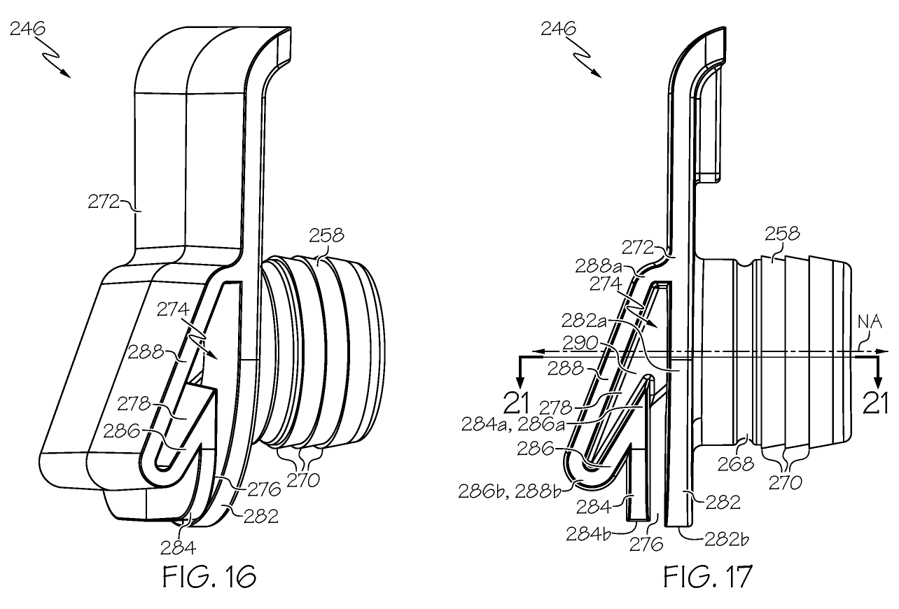

With reference to FIGS. 16-20, a nozzle 246 for use with the toilet assembly 20 is shown. The nozzle 246 may be used, for example, instead of the nozzle 46 to provide liquid to the bowl 24 shown in FIGS. 3 and 11. The nozzle 246 may include a generally cylindrical portion 258 with a recess 268 that engages with the first inner protrusion 166 of the connector 150 to provide a tool-less coupling between the connector 150 and the nozzle 246 without a compression collar, e.g., as described herein for the nozzle 46, the generally cylindrical portion 158, the first inner protrusion 166, the connector 150, and the first inner protrusion 166 and as shown in FIG. 11. The nozzle 246 may include one or more barbs 270. The barbs 270 may be distal to the recess 268. For example, the recess 268 may be positioned on the generally cylindrical portion 258 between the barbs 270 and a main body 272 that controls distribution of liquid from the nozzle 246. The recess 268 extends radially inward into the generally cylindrical portion 258 and the barbs 270 extend radially outward from the generally cylindrical portion 258. The nozzle 246 may provide improved liquid distribution, e.g., relative to other nozzle designs.

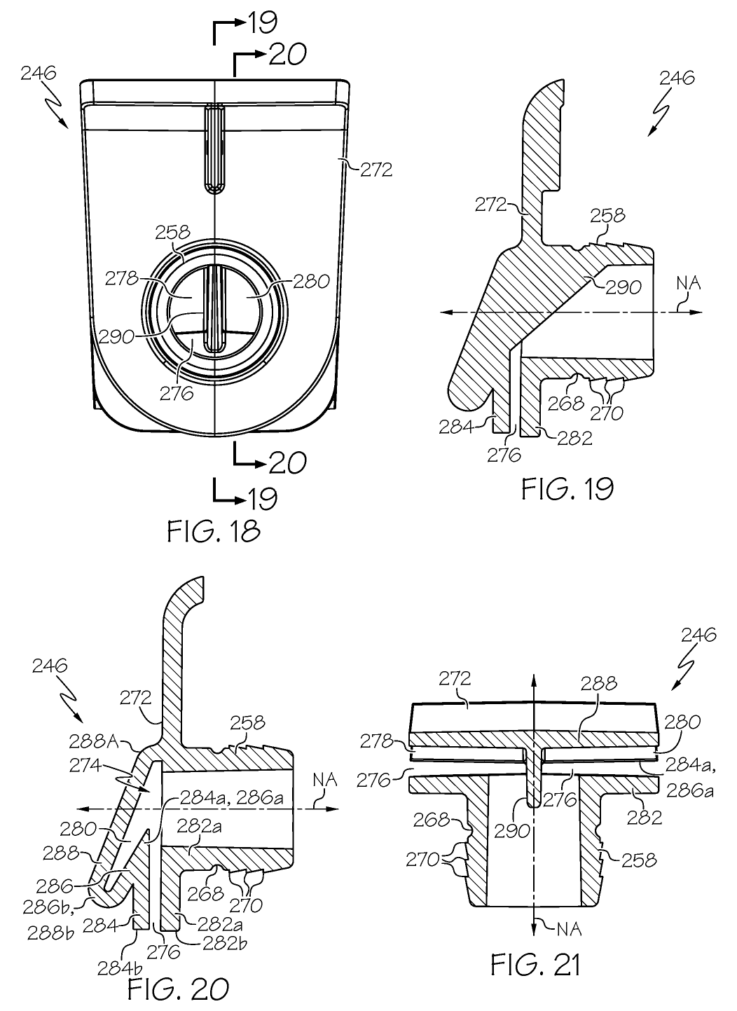

The nozzle 246, e.g., the main body 272, defines a liquid distribution passage 274 having at least one first portion 276 and/or one or more second portions 278, 280. The one or more second portions 278, 280 may include a first second portion 278, e.g., at a left side of the nozzle 246, as shown in FIG. 17. The one or more second portions 278, 280 may include a second second portion 280, e.g., at a right side of the nozzle 246, as shown in FIG. 20. Both the first and the second second portions 278, 280 are shown in FIGS. 18 and 21. The first portion 276 and the one or more second portions 278, 280 are in fluid communication with the generally cylindrical portion 258 such that liquid can flow from within the generally cylindrical portion 258 to the first portion 276 and the one or more second portions 278, 280. The first portion 276 and the one or more second portions 278, 280 may direct flow of liquid received via the generally cylindrical portion 258 through, and out of the main body 272, e.g., into the bowl 24.

With reference to FIGS. 17 and 20, the first portion 276 may extend downward, e.g., generally perpendicular to a nozzle axis NA that axially extends through the generally cylindrical portion 258. The first portion 276 may be defined between a first wall 282 and a second wall 284 of the main body 272. The first wall 282 and the second wall 284 may extend generally perpendicular to the nozzle axis NA. The generally cylindrical portion 258 may extend rearward from the first wall 282 along the nozzle axis NA. The second wall 284 may be spaced forward of the first wall 282 along the nozzle axis NA with the first portion 276 defined in the space provided therebetween. A top end 282a of the first wall 282 may be spaced, e.g., along the nozzle axis NA, from a top distal end 284 of the second wall 284, e.g., such that liquid may enter the first portion 276 therebetween. A bottom distal end 282b of the first wall 282 may be spaced, e.g., along the nozzle axis NA, from a bottom distal end 284b of the second wall 284, e.g., such that liquid may exit the first portion 276 therebetween. The first portion 276 may be open in a downward direction, as shown in FIGS. 17 and 20, and may be open in opposing lateral directions, e.g., to a right and a left, as show in FIG. 21.

With continued reference to FIGS. 17 and 20, the second portions 278, 280 may extend downward and forward, e.g., away from the generally cylindrical portion 258 and obliquely relative to the nozzle axis NA and/or the first portion 276. The second portions 278, 280 may be defined between a third wall 286 and a fourth wall 288 of the main body 272. The third wall 286 and the fourth wall 288 may extend downward and forward, e.g., away from the generally cylindrical portion 258 and obliquely relative to the nozzle axis NA, the first wall 282, and/or the second wall 284. A top distal end 286a of the third wall 286 may be connected to the top distal end 284a of the second wall 284. For example, the second wall 284 may extend downward from the top distal end 286a of the third wall 286, and the third wall 286 may extend forward and downward from the top distal end 284a of the second wall 284. The fourth wall 288 may extend forward and downward from at or above a top of the generally cylindrical portion 258. The second portions 278, 280 may be open in opposing lateral directions, e.g., to a right and a left, e.g., as show in FIG. 21.

With further reference to FIGS. 17 and 20, the third wall 286 may be spaced from the fourth wall 288 and define the second portions 278, 280 therebetween. A top distal end 288a of the fourth wall 288 may be spaced above the top distal 286a end of the third wall 286, e.g., such that liquid can enter the second portions 278, 280 between the top distal end 286a of the third wall 286 and the top distal end 288a of the fourth wall 288. A bottom distal end 286b of the third wall 286 may be connected to a bottom distal end 288b of the fourth wall 288 to close the second portions 278, 280 of the liquid distribution passage 274 at the bottom distal ends 286b, 288b such that the second portions 278, 280 are closed in downward and forward directions. The third wall 286 and the fourth wall 288 may extend obliquely relative to each other and obliquely relative to the first wall 282 and the second wall 284.

With reference to FIGS. 17-19 and 21, the nozzle 246 may include a divider 290 that separates the second portions 278, 280 from each other. For example, the first second portion 278 may be on a left side of the divider 290 and the second second portion 280 may be on a right side of the divider 290, as shown in FIGS. 18 and 21. As shown in FIGS. 17 and 19, the divider 290 may extend from within the generally cylindrical portion 258 to the top distal end 286a of the third wall 286 and the top distal end 288a of the fourth wall 288. The divider 290 may extend from the third wall 286 to the fourth wall 288, e.g., along an entire length of the third wall 286 and/or the fourth wall 288 from the top distal ends 286a, 288a to the bottom distal ends 286b, 288b. The divider 290 may separate and direct liquid from the generally cylindrical portion 258 to the first second portion 278 on the left and to the second second portion 280 on the right. Liquid may flow laterally out of the right and left second portions 278, 280 to be dispersed, e.g., along sides and toward the front F of the bowl 24 shown in FIG. 3.

From the above, it is to be appreciated that defined herein is a toilet assembly for use in a vehicle and that provides a smaller footprint, increased ease of installation and/or assembly, and/or improved performance.

It is noted that the terms "substantially" and "about" may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Further aspects of the embodiments described herein are provided by the subject matter of the following clauses:

A toilet assembly comprises a pedestal and a bowl supported by the pedestal. The bowl includes a top bowl piece and a bottom bowl piece. The top bowl piece includes a first bowl portion and an outlet at a bottom of the first bowl portion. The bottom bowl piece includes a bottom portion that defines an opening. The outlet of the top bowl piece extends through the opening of the bottom portion toward the pedestal.

The toilet assembly of any of the above clauses, wherein the top bowl piece includes one or more supports mechanically connecting the top bowl piece to the bottom bowl piece and the bottom bowl piece includes one or more bases mechanically connecting the top bowl piece and the bottom bowl piece.

The toilet assembly of any of the above clauses, wherein one or more of the bases define pockets and one or more of the supports are disposed in the pockets of one or more of the bases.

The toilet assembly of any of the above clauses, further comprising a hinge bracket supported by the bowl and a fastener extending through one of the bases of the bottom portion and through the top bowl piece to the hinge bracket.

The toilet assembly of any of the above clauses, further comprising a fastener extending through the pedestal, through one of the bases of the bottom bowl piece, and into one of the supports of the top bowl piece.

The toilet assembly of any of the above clauses, further comprising a seal extending circumferentially around the outlet and a flush ball movable from a closed position to an open position, the flush ball at the closed position abutting the seal.

The toilet assembly of any of the above clauses, wherein the seal defines a channel and the outlet includes a lip disposed in the channel of the seal.

The toilet assembly of any of the above clauses, wherein the lip extends radially inward.

The toilet assembly of any of the above clauses, wherein the bottom portion includes an upward extending wall surrounding the opening and the outlet and extending away from the pedestal.

The toilet assembly of any of the above clauses, wherein the top bowl piece includes an outer portion that defines a bottom channel and the bottom bowl piece includes a top edge disposed in the bottom channel.

The toilet assembly of any of the above clauses, wherein the bottom bowl piece includes a second bowl portion positioned below the first bowl portion, the second bowl portion having a class-A outer surface.

The toilet assembly of any of the above clauses, further comprising a connector defining a passage and having a cylinder body extending from a first open distal end to a second open distal end opposite the first open distal end, the connector including a first lip that extends radially outward at the first open distal end, the connector having an outer protrusion proximate the first open distal end, the connector defining a channel between the first lip and the outer protrusion, and wherein the top bowl piece is disposed in the channel.

The toilet assembly of any of the above clauses, further comprising a nozzle having a first cylindrical portion within the passage at the first open distal end and a vacuum breaker having a second cylindrical portion disposed within the passage at the second distal open end.

The toilet assembly of any of the above clauses, wherein the connector includes a divider in the passage between the first open distal end and the second open distal end, the divider between the second cylindrical portion of the vacuum breaker and the first cylindrical portion of the nozzle.

The toilet assembly of any of the above clauses, wherein the divider abuts the second cylindrical portion of the vacuum breaker and the first cylindrical portion of the nozzle.

The toilet assembly of any of the above clauses, wherein the connector is coupled to the nozzle and the vacuum breaker without a compression collar.

The toilet assembly of any of the above clauses, wherein the connector includes a first inner protrusion proximate the first open distal end and a second inner protrusion proximate the second open distal end, the first inner protrusion is engaged with a first recess of the first cylindrical portion of the nozzle, and the second inner protrusion is engaged with a second recess of the second cylindrical portion of the vacuum breaker.

The toilet assembly of any of the above clauses, wherein the bowl defines a rinse passage that extends around a perimeter of the bowl, the rinse passage is defined between a top wall, a bottom wall, an outer wall and an inner wall of a top portion of the bowl, and the bottom wall at a front of the bowl is lower than the bottom wall at a rear of the bowl such that gravity urges fluid in the rinse passage away from the rear and toward the front.

The toilet assembly of any of the above clauses, wherein a first distance from a top surface of the bottom wall at the front of the bowl to a bottom distal edge of the pedestal is less than a second distance from the top surface of the bottom wall at the rear of the bowl to the bottom distal edge of the pedestal.

The toilet assembly of any of the above clauses, wherein bowl includes a plurality of rinse holes arranged at intervals along the bottom wall.

A toilet assembly comprises a bowl and a nozzle positioned to deliver liquid to the bowl. The toilet assembly comprises a vacuum breaker configured to prevent liquid from being siphoned backward from the nozzle. The toilet assembly comprises a connector coupled with the bowl and fluidly coupling the nozzle and the vacuum breaker without a compression collar.

The toilet assembly of any of the above clauses, wherein the connector defines a passage and has a cylinder body extending from a first open distal end to a second open distal end opposite the first open distal end, the connector including a first lip that extends radially outward at the first open distal end, the connector having an outer protrusion proximate the first open distal end, the connector defining a channel between the first lip and the outer protrusion, and wherein the bowl is disposed in the channel.

The toilet assembly of any of the above clauses, wherein the nozzle has a first cylindrical portion within the passage at the first open distal end and the vacuum breaker has a second cylindrical portion disposed within the passage at the second distal open end.

The toilet assembly of any of the above clauses, wherein the connector includes a divider in the passage between the first open distal end and the second open distal end, the divider between the second cylindrical portion of the vacuum breaker and the first cylindrical portion of the nozzle.

The toilet assembly of any of the above clauses, wherein the divider abuts the second cylindrical portion of the vacuum breaker and the first cylindrical portion of the nozzle.

The toilet assembly of any of the above clauses, wherein the connector includes a first inner protrusion proximate the first open distal end and a second inner protrusion proximate the second open distal end, the first inner protrusion is engaged with a first recess of the first cylindrical portion of the nozzle, and the second inner protrusion is engaged with a second recess of the second cylindrical portion of the vacuum breaker.

The toilet assembly of any of the above clauses, wherein the nozzle includes a main body that defines a liquid distribution passage having a first portion and one or more second portions, the first portion extending downward and the one or more second portions extending downward and forward.

The toilet assembly of any of the above clauses, wherein the first portion of the liquid distribution passage is open in a downward direction and open in opposing lateral directions, and wherein the one or more second portions of the liquid distribution passage are open in opposing lateral directions and closed in downward and forward directions.

The toilet assembly of any of the above clauses, wherein the one or more second portions of the liquid distribution passage include a first second portion and a second second portion, and wherein the nozzle includes a divider that separates the first second portion from the second second portion.

The toilet assembly of any of the above clauses, wherein the generally cylindrical portion of the nozzle has a recess and a plurality of barbs.

The toilet assembly of any of the above clauses, wherein the recess of the nozzle is between the main body of the nozzle and the barbs of the nozzle.

The toilet assembly of any of the above claims, wherein the main body includes a first wall and a second wall spaced from the first wall, the first portion of the liquid distribution passage defined between the first wall and the second wall.

The toilet assembly of any of the above claims, wherein the main body includes a third wall and a fourth wall spaced from the third wall, the one or more second portions of the liquid distribution passage defined between the third wall and the fourth wall.

The toilet assembly of any of the above claims, wherein the third wall and the fourth wall extend obliquely relative to the first wall and the second wall.

The toilet assembly of any of the above claims, wherein the third wall extends obliquely relative to the fourth wall.

The toilet assembly of any of the above claims, wherein a bottom distal end of the third wall is connected to a bottom distal end of the fourth wall and closes the one or more second portions of the liquid distribution passage at the bottom distal ends of the third wall and the fourth wall.

The toilet assembly of any of the above clauses, further comprising a hinge bracket supported by the bowl, the hinge bracket including a front portion, a first side portion extending rearward from the front portion, a second side portion extending rearward from the front portion and spaced from the second side portion, the hinge bracket defining a gap volume between the first side portion and the second side portion, and the vacuum breaker is disposed in the gap volume.

The toilet assembly of any of the above clauses, further comprising a pedestal supporting the bowl, a flush lever fixed to the pedestal below the bowl, and a hose fluidly coupling the flush lever to the vacuum breaker.

A toilet assembly comprises a bowl and a seat supported by the bowl. The seat is moveable from a down position to an up position. The toilet assembly comprises a hinge bracket supported by the bowl and pivotally coupling the seat to the bowl, the hinge bracket having an open bottom that faces the bowl and a rib extending toward the open bottom. toilet assembly comprises a damper bracket fixed to the rib. The toilet assembly comprises a slow-close damper connected to the damper bracket, the slow close damper configured to control movement of the seat.

The toilet assembly of any of the above clauses, wherein the damper bracket includes a clasp and the slow-close damper includes a post coupled to the clasp.

The toilet assembly of any of the above clauses, wherein the damper bracket includes a first portion and a second portion spaced from the first portion with a slot defined between the first portion and the second portion, the rib disposed in the slot.

The toilet assembly of any of the above clauses, wherein the damper bracket includes a clasp at a distal end of the first portion, and the slow-close damper includes a post coupled to the clasp.

The toilet assembly of any of the above clauses, wherein the hinge bracket includes a second rib, and further comprising a lid supported by the bowl, a second damper bracket fixed to the second rib, and a second slow-close damper connected to the second damper bracket, the second slow close damper configured to control movement of the lid.

The toilet assembly of any of the above clauses, wherein the hinge bracket includes a front portion, a first side portion extending rearward from the front portion, a second side portion extending rearward from the front portion and spaced from the second side portion, and wherein the damper bracket is at the first side portion and the second damper bracket is at the second side portion.

The toilet assembly of any of the above clauses, wherein damper bracket and the second damper bracket each include a first portion and a second portion spaced from the first portion with a slot defined between the first portion and the second portion, the rib disposed in the slot of the damper bracket and the second rib disposed in the slot of the second damper bracket.

The toilet assembly of any of the above clauses, wherein the hinge bracket defines a gap volume between the first side portion and the second side portion, and the first portion of the damper brackets and the first portion of the second damper bracket both face the gap volume.

The toilet assembly of any of the above clauses, further comprising a seat hold mechanism that includes a cam fixed to the seat and a reaction body fixed to the hinge bracket.

The toilet assembly of any of the above clauses, wherein rotation of the seat toward the up position increases pressure applied to the reaction body by the cam, rotation of the seat toward the down position decrease pressures applied to the reaction body by the cam, and pressure between the cam and the reaction body at the up position provides sufficient reaction forces therebetween to maintain the seat at the up position.

The toilet assembly of any of the above clauses, wherein the cam includes a radial outer surface having a movement portion configured to permit movement of the seat from the down position to the up position and a stop portion configured to maintain the seat at the up position, the radial outer surface is smooth and continuous along the movement portion and the stop portion.

The toilet assembly of any of the above clauses, wherein the reaction body includes a finger elongated away from the bowl.

The toilet assembly of any of the above clauses, wherein the reaction body includes a horn supported by the reaction body along a rear and a bottom of the horn.

A toilet assembly comprises a bowl and a seat supported by the bowl. The seat is moveable from a down position to an up position. The toilet assembly comprises a hinge bracket supported by the bowl and pivotally coupling the seat to the bowl. The toilet assembly comprises a seat hold mechanism that includes a cam fixed to the seat and a reaction body fixed to the hinge bracket. The cam includes a radial outer surface having a movement portion configured to permit movement of the seat from the down position to the up position and a stop portion configured to maintain the seat at the up position. The radial outer surface is smooth and continuous along the movement portion and the stop portion.

The toilet assembly of any of the above clauses, wherein rotation of the seat toward the up position increases pressure applied to the reaction body by the cam, rotation of the seat toward the down position decrease pressures applied to the reaction body by the cam, and pressure between the cam and the reaction body at the up position provides sufficient reaction forces therebetween to maintain the seat at the up position.

The toilet assembly of any of the above clauses, wherein the radial outer surface includes a blocked portion configured to prevent movement of the seat past the up position, the radial outer surface is smooth and continuous along the movement portion, the stop portion, and the blocked portion.

The toilet assembly of any of the above clauses, wherein the radial outer surface includes an area of localized radial decrease at the stop portion.

The toilet assembly of any of the above clauses, wherein the reaction body includes a finger elongated away from the bowl.

The toilet assembly of any of the above clauses, wherein the reaction body includes a horn supported by the reaction body along a rear and a bottom of the horn.

A toilet assembly comprises a pedestal and a bowl supported by the pedestal. The bowl defines a rinse passage that extends around a perimeter of the bowl. The rinse passage is defined between a top wall, a bottom wall, an outer wall and an inner wall of a top portion of the bowl. The bottom wall at a front of the bowl is lower than the bottom wall at a rear of the bowl such that gravity urges fluid in the rinse passage away from the rear and toward the front.

The toilet assembly of any of the above clauses, wherein a first distance from a top surface of the bottom wall at the front of the bowl to a bottom distal edge of the pedestal is less than a second distance from the top surface of the bottom wall at the rear of the bowl to the bottom distal edge of the pedestal.

The toilet assembly of any of the above clauses, wherein bowl includes a plurality of rinse holes arranged at intervals along the bottom wall.

The toilet assembly of any of the above clauses, further comprising an expansion fastener securing the bowl to the pedestal, the expansion fastener having a cylinder body, a flange that extends radially outward from the cylinder body, a first leg and a second leg that both extend axially from the cylinder body, the first leg and the second leg spaced from each other and defining passages therebetween, the expansion fastener including a wedge, one or more first supports extending circumferentially from the first leg and the second leg to the wedge, and one or more second supports extending axially from the first leg and the second leg to the wedge

A toilet assembly comprises a pedestal and a bowl supported by the pedestal. The toilet assembly comprises an expansion fastener securing the bowl to the pedestal. The expansion fastener comprises a cylinder body and a flange that extends radially outward from the cylinder body. The expansion fastener comprises a first leg that extends axially from the cylinder body. The expansion fastener comprises a second leg that extends axially from the cylinder body. The first leg and the second leg are spaced from each other and define passages therebetween. The expansion fastener comprises a wedge spaced from the first leg and the second leg. The expansion fastener comprises one or more first supports extending circumferentially from the first leg and the second leg to the wedge. The expansion fastener comprises one or more second supports extending axially from the first leg and the second leg to the wedge.

The toilet assembly of any of the above clauses, wherein the first leg and the second leg each have a plurality of grooves.

The toilet assembly of any of the above clauses, wherein the grooves are elongated circumferentially along outer surfaces of the first leg and the second leg.

The toilet assembly of any of the above clauses, wherein one or more of the grooves engage the bowl.

The toilet assembly of any of the above clauses, wherein the wedge is disposed within the passages between the first leg and the second leg.

The toilet assembly of any of the above clauses, wherein ends of the first leg and the second leg slope outward such that a circumferential width of the passages increases at the ends of the first leg and the second leg.

An expansion fastener for securing a bowl of a toilet assembly to a pedestal of a toilet assembly comprises a cylinder body and a flange that extends radially outward from the cylinder body. The expansion fastener comprises a first leg that extends axially from the cylinder body. The expansion fastener comprises a second leg that extends axially from the cylinder body, the first leg and the second leg spaced from each other and defining passages therebetween. The expansion fastener comprises a wedge spaced from the first leg and the second leg. The expansion fastener comprises one or more first supports extending circumferentially from the first leg and the second leg to the wedge. The expansion fastener comprises one or more second supports extending axially from the first leg and the second leg to the wedge.

The expansion fastener of any of the above clauses, wherein the first leg and the second leg each have a plurality of grooves.

The expansion fastener of any of the above clauses, wherein the grooves are elongated circumferentially along outer surfaces of the first leg and the second leg.

The expansion fastener of any of the above clauses, wherein the wedge is disposed within the passages between the first leg and the second leg.

The expansion fastener of any of the above clauses, wherein ends of the first leg and the second leg slope outward such that a circumferential width of the passages increases at the ends of the first leg and the second leg.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A toilet assembly, comprising:
a pedestal;
a bowl supported by the pedestal, the bowl including a top bowl piece and a bottom bowl piece;
the top bowl piece includes a first bowl portion and an outlet at a bottom of the first bowl portion;
the bottom bowl piece includes a bottom portion that defines an opening; and
the outlet of the top bowl piece extends through the opening of the bottom portion toward the pedestal.

2. The toilet assembly of claim 1, wherein the top bowl piece includes one or more supports mechanically connecting the top bowl piece to the bottom bowl piece and the bottom bowl piece includes one or more bases mechanically connecting the top bowl piece and the bottom bowl piece.

3. The toilet assembly of claim 2, wherein one or more of the bases define pockets and one or more of the supports are disposed in the pockets of one or more of the bases.

4. The toilet assembly of claim 2, further comprising a hinge bracket supported by the bowl and a fastener extending through one of the bases of the bottom portion and through the top bowl piece to the hinge bracket.

5. The toilet assembly of claim 2, further comprising a fastener extending through the pedestal, through one of the bases of the bottom bowl piece, and into one of the supports of the top bowl piece.

6. The toilet assembly of claim 1, further comprising a seal extending circumferentially around the outlet and a flush ball movable from a closed position to an open position, the flush ball at the closed position abutting the seal.

7. The toilet assembly of claim 6, wherein the seal defines a channel and the outlet includes a lip disposed in the channel of the seal.

8. The toilet assembly of claim 7, wherein the lip extends radially inward.

9. The toilet assembly of claim 1, wherein the bottom portion includes an upward extending wall surrounding the opening and the outlet and extending away from the pedestal.

10. The toilet assembly of claim 1, wherein the top bowl piece includes an outer portion that defines a bottom channel and the bottom bowl piece includes a top edge disposed in the bottom channel.

11. The toilet assembly of claim 1, wherein the bottom bowl piece includes a second bowl portion positioned below the first bowl portion, the second bowl portion having a class-A outer surface.

12. The toilet assembly of claim 1, further comprising a connector defining a passage and having a cylinder body extending from a first open distal end to a second open distal end opposite the first open distal end, the connector including a first lip that extends radially outward at the first open distal end, the connector having an outer protrusion proximate the first open distal end, the connector defining a channel between the first lip and the outer protrusion, and wherein the top bowl piece is disposed in the channel.

13. The toilet assembly of claim 12, further comprising a nozzle having a first cylindrical portion within the passage at the first open distal end and a vacuum breaker having a second cylindrical portion disposed within the passage at the second open distal end.

14. The toilet assembly of claim 13, wherein the connector includes a divider in the passage between the first open distal end and the second open distal end, the divider between the second cylindrical portion of the vacuum breaker and the first cylindrical portion of the nozzle.

15. The toilet assembly of claim 14, wherein the divider abuts the second cylindrical portion of the vacuum breaker and the first cylindrical portion of the nozzle.

16. The toilet assembly of claim 13, wherein the connector is coupled to the nozzle and the vacuum breaker without a compression collar.

17. The toilet assembly of claim 13, wherein the connector includes a first inner protrusion proximate the first open distal end and a second inner protrusion proximate the second open distal end, the first inner protrusion is engaged with a first recess of the first cylindrical portion of the nozzle, and the second inner protrusion is engaged with a second recess of the second cylindrical portion of the vacuum breaker.

18. The toilet assembly of claim 1, wherein the bowl defines a rinse passage that extends around a perimeter of the bowl, the rinse passage is defined between a top wall, a bottom wall, an outer wall and an inner wall of a top portion of the bowl, and the bottom wall at a front of the bowl is lower than the bottom wall at a rear of the bowl such that gravity urges fluid in the rinse passage away from the rear and toward the front.

19. The toilet assembly of claim 18, wherein a first distance from a top surface of the bottom wall at the front of the bowl to a bottom distal edge of the pedestal is less than a second distance from the top surface of the bottom wall at the rear of the bowl to the bottom distal edge of the pedestal.

20. The toilet assembly of claim 19, wherein the bowl includes a plurality of rinse holes arranged at intervals along the bottom wall.
